(19) United States
(12) Patent Application Publication
(10) Pub. No.: US 2003/0005421 A1
(43) Pub. Date: Jan. 2, 2003

(54) Interprocedural optimization framework

(76) Inventors: Raj Prakash, Saratoga, CA (US); Fu-Hwa Wang, Saratoga, CA (US); Chandrashekhar Garud, Mountain View, CA (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 09/895,445

(22) Filed: Jun. 29, 2001

(51) Int. Cl. G06F 9/45

(52) U.S. Cl. 717/152

(57) ABSTRACT

High level program files are compiled into an efficient machine readable output file by using an optimizer that processes program files into intermediate files and reprocesses the intermediate files extracting necessary information to maintain. Information is provided in intermediate files that relate to dependency and interrelationships between target files that are to be compiled. If program files are modified and the compilation process must be re-done, interrelationship content is maintained to allow files to be compiled with undue calculations.

### BACKGROUND OF THE INVENTION

1. Field of the Invention

This invention relates to a method and a system for optimizing compilers in a computer system.

2. Description of the Related Art

Programmers create pieces of software code in a high-level language such as C programming language. A computer (i.e., machine) does not understand the high-level language that is developed by the programmers. Therefore, high-level software programs have to be compiled down to machine-readable code, sometimes known as object code. There can be hundreds or thousands of programs that are developed by different programmers. These various high-level program files must be related to one another. Ultimately, the programs are linked to one another to create a single machine language file.

The various high-level program files can either pass through one or more compilers. Intermediate forms of the high-level language can be created. Files can be connected together by a linker. The final result is a single output file that is readable by the computer (i.e., machine). This compilation process can be lengthy. Oftentimes the high-level computer program files are modified, revised or changed necessitating the need to recompile, relink and to create a new output file, thus restarting the compilation process.

Part of the compilation process of getting program files into a machine-readable output file language includes the use of an optimizer. An optimizer provides efficiencies in generating object files. An optimizer is able to make use of certain heuristics. Heuristics are rules that relate to computation and processing of computer commands and instructions. Heuristics can be learned by the optimizer based on program files that the optimizer receives. Heuristics can also be programmed into the optimizer depending on the type of high-level program files to be compiled. The optimizer provides for more efficient output programs. An optimizer allows for efficiencies in calculation, including a reduction of computing steps. Output programs run faster and more efficiently. Typically, an optimizer looks at each of the individual files of the multiple program files. An optimizer looks individually at each program file and optimizes for that particular program file. In other words, the multiple files that exist will be compiled separately, one from the other. The numerous program files, however, eventually become one machine object file and, therefore an optimizer should look at the total set of program files when an optimization is performed.

To get the full benefit of the optimizer the optimizer must be able to work on all program files together and not just individually. Typically, this is achieved by specifying all files on one command line. This process has several drawbacks. Makefiles are files typically written to a generate machine object file for each source file. Specifying all source files in one line requires reorganizing these makefiles in a significant manner. Users sometimes forego optimizations to avoid having to reorganize makefiles.

Another drawback of specifying all files in the same command line is that all options on the command line would apply to all files. Therefore, all files must be compiled with the same set of options. This behavior may not be desired. In other words, a single source file can be used to generate different object files to be linked to one another. The problem is that the different object files require different options.

Typically, implementations that support optimizations of multiple files together do not maintain any dependency information. Therefore, whenever there is a change in any source file, recompilation of all files is required. This complete recompilation is required even if the change has no impact on the optimizations that were performed.

Implementations also restrict the usage of machine object files that are prepared for whole program optimization. Typically, the machine object files that are compiled for the purpose of whole program optimization cannot be used to make any other executable program. This restriction also causes users to reorganize makefiles in order to separate the files that are to be optimized in the whole program optimization from the files that are not.

Therefore, there has been found a need for a method and a system that will make use of an optimizer that simultaneously interrelates and makes use of multiple program files in creating an efficient output file.

### SUMMARY OF THE INVENTION

The aforementioned and other features are accomplished, by providing a method and system or framework that optimizes program files and creates objects files. The object files contain necessary information regarding their status as having gone through the optimization process. Additional information includes functional relationships that are maintained between program files or modules. The objects files are linked with one another to create an executable machine output file.

In certain embodiments of the invention, intermediate representation files are created prior to optimizing program files. The intermediate representation files provide for a simpler version of the program file that can be used in the compilation process.

In other embodiments of the invention information can be provided in the object files that includes code generator information describing specific code generator or generators that create(s) machine readable code.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and it's numerous objects, features and advantages made apparent to those skilled in the art by referencing the accompanying drawings. The use of the same reference number throughout the figures designates a like or similar element.

FIG. 1 is a flow chart illustrating converting program files to object files.

FIG. 2 is a block diagram showing multiple target program files creating one single output file.

FIG. 3 is a block diagram illustrating a process that compiles target object files into an output file using an optimizer.

FIG. 4 is a block diagram illustrating a compilation process using an interprocedural optimizer.

FIG. 5 is a block diagram illustrating the use of all pre-IPO files and an optimizer to create an output file.

FIG. 6 is a block diagram illustrating a network environment in which a system according to the present invention may be practiced

FIG. 7 depicts a block diagram of a computer system suitable for implementing the present invention.

FIG. 8 is a block diagram depicting a network in which computer system is coupled to an internetwork, which is coupled, in turn, to client systems as well as a server.

While the invention is susceptible to various modifications and alternative forms, specific embodiments thereof are shown by way of example in the drawings and will herein be described in detail, it should be understood, however, that the drawings and detailed description thereto are not intended to limit the invention to the particular form disclosed but on the contrary, the intention is to cover all modifications, equivalents, and alternatives falling within the scope of the present invention as defined by the appended claims.

### DETAILED DESCRIPTION OF THE INVENTION

An interprocedural optimizer (IPO) framework uses a two-phase compilation system. The first phase creates object files with the extension “.o”. The second phase links these objects files to generate an executable output file. The IPO framework works within this process, which allows it to be seamlessly integrated in the user environment. The IPO framework can be invoked by an option -xipo.

A single invocation point in the compilation process is made available that will allow source files to be presented and to perform an interprocedural optimization. The invocation point can take place during link time when the objects files are made available for linking.

The IPO framework uses the IPO as a component in the compilation process. The IPO is invoked only within the compiler, not directly by users. IPO is invoked once each time a source file is compiled to an object file. IPO is further invoked when the object files are linked together.

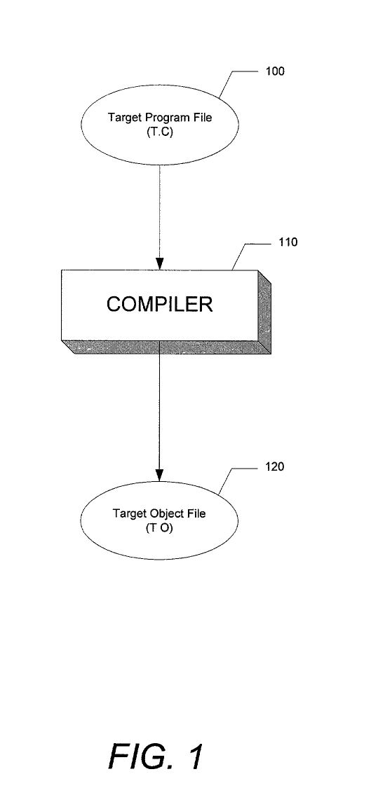

FIG. 1 is a flow chart illustrating converting program files to object files. A target program file t.c 100 is created by a programmer in a high-level language such as C. A number of these target program files can be created and compiled. A target program file and its derivatives can be called a module. Modules can be loaded, related, and or compiled with on another. The target program file t.c 100 is sent to a compiler 110. Compiler 110 takes the target program file t.c 100 and converts it to a machine-readable object file. Target object file t.o 120 is the product of the compiler. Target object file t.o 120 is a machine-readable file.

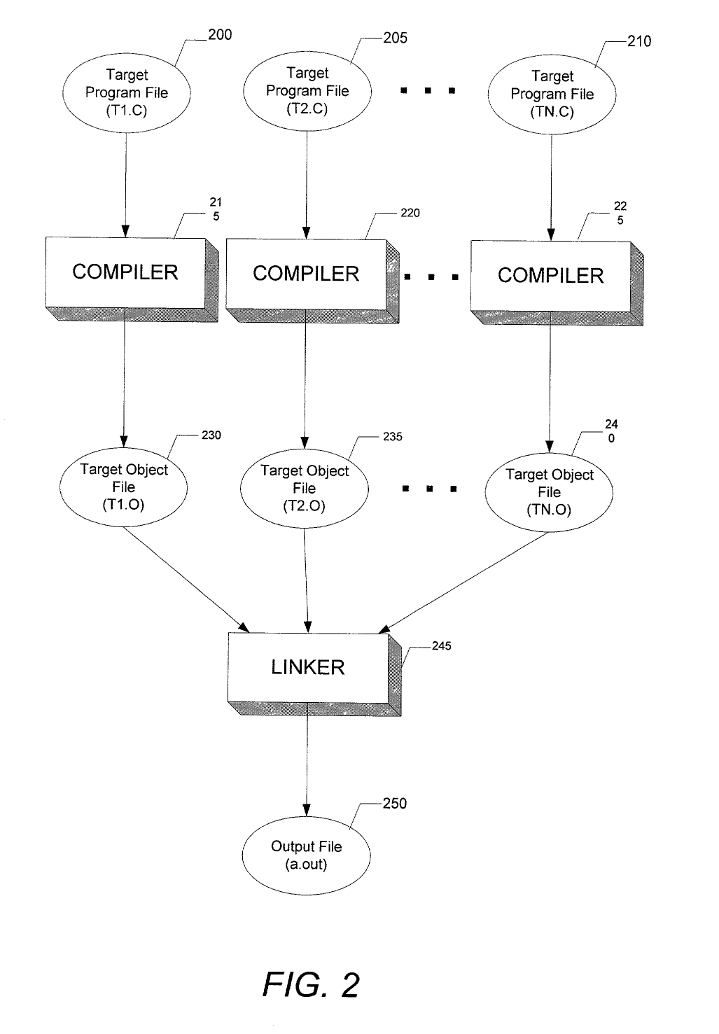

FIG. 2 is a block diagram showing multiple target program files creating one single output file. A target program file t1.c 200 is created by a programmer. Other target program files can be created by the same programmer or various other programmers. The set of target program files can include a target program file t2.c 205 up to and including target program file tn.c 210. Thousands of these program files can exist. Target program file t1.c 200 is passed through compiler 215. Target program file t2.c 205 is passed through compiler 220. Target program file tn.c 210 is passed through compiler 225. Compiler 215, compiler 220 and compiler 225 can be the same or different compilers. From a compiler, object files are created. In this particular example, target object file t1.o 230 is created from target program file t1.c 200. A target object file t2.o 235 is created originating from target program file t2.c 205. Multiple target object files are created up to and including target object file tn.o 240, which originates from target program file tn.c 210. Target object file t1.o 230, target object file t2.o 235, up to and including target object file tn.o 240, are all linked to one another using a linker 245. Once linked, these target object files are created to a single output file a.out 250.

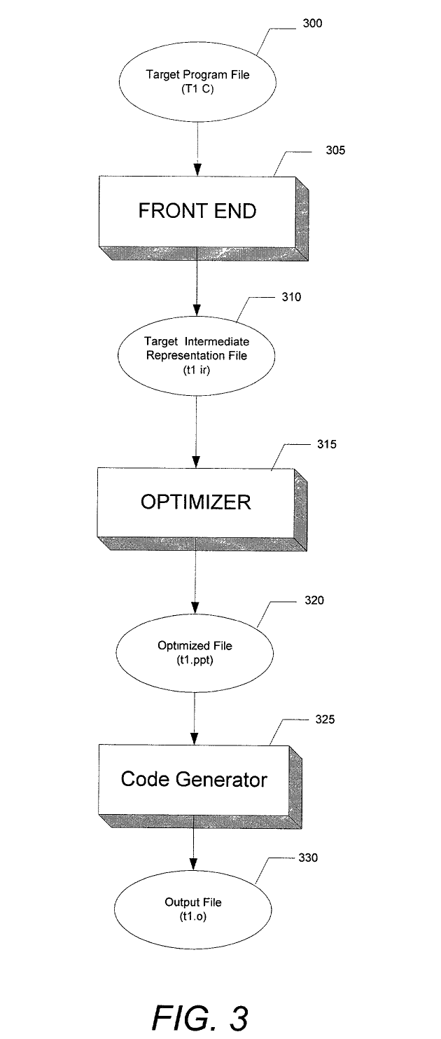

FIG. 3 is a block diagram illustrating a process that compiles target object files into an output file using an optimizer. A target program file t1.c 300 is created by a programmer in a high-level language such as C. The target object file 300 is passed through a front end 305. The front end 305 is a process that generates a target intermediate representation file. A software driver can invoke the front end 305 for each target program file such as t1.c 300 to generate intermediate representation files. Front end 305 creates target intermediate representation file t1.ir 310. Target intermediate representation file t1.ir 310 is passed on to an optimizer 315. Optimizer 315 creates a streamline and simplistic optimized, optimize file t1.opt 320. Optimized file t1.opt 320 is passed on to a code generator 325. Code generator 325 creates a machine-readable file output file t1.o 330.

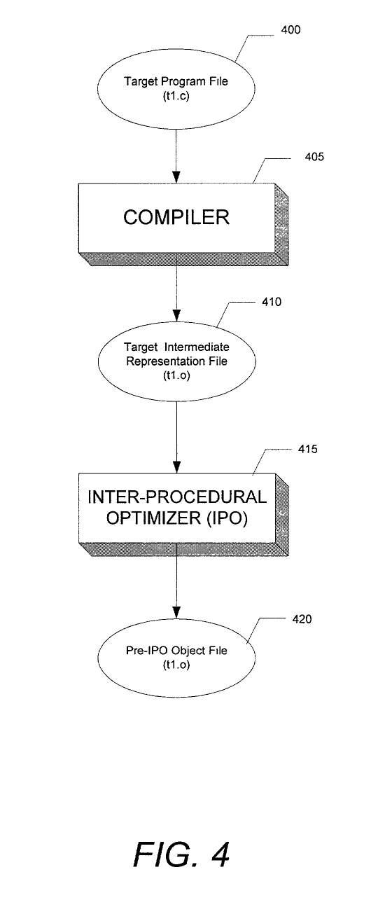

FIG. 4 is a block diagram illustrating a compilation process using an interprocedural optimizer. A target program file t1.c is created 400. Target program file 400 is passed on to compiler 405. From compiler 405, a target machine object file t1.o 410 is created. File t1.o 410 are passed on to an inteprocedural optimizer (IPO) 415. IP0 415 augments file t1.o 410 with internal representation of the program and creates an enhanced machine object file, referred to as PreIPO object file 420. The added information enables the downstream processes to optimize the whole program using this PreIPO object file 420.

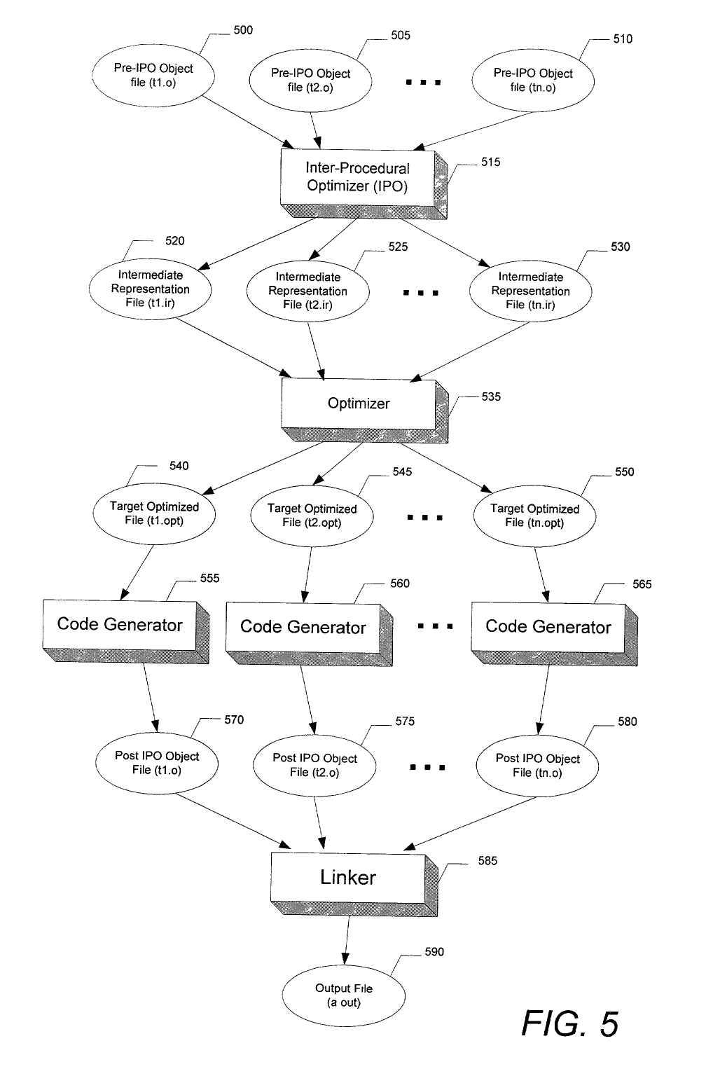

FIG. 5 is a block diagram illustrating the use of all pre-IPO files and an optimizer to create an output file. A number of pre-IPO object files are made available. In this example there are pre-IPO files t1.o 500, t2.o 505, up to and including tn.o 510. Pre-IPO object files t1.o 500, t2.o 505, up to an including tn.o 510 are processed by an optimizer. In this embodiment the optimizer is an IPO 515. IPO 515 looks at all the individual files and optimizes for other files. IPO 515 using these individual files further provides specific options to be made available from IPO 515 to the optimizer and code generator(s).

Intermediate representation files t1.1r 520, t2.ir 525, up to and including tn.ir 530 are created by IPO 515. The intermediate representative files are reprocessed as a group by an optimizer 535. Target optimized files are created by optimizer 535. These target optimized files include files t1.opt 540, t2.opt 545, and tn.opt 550. In this second process through an optimizer 535, optimized files use specific optimizer options as given by the user. These specific options are extracted from the Pre-IPO object files t1.o 500, t2.o 505, up to and including, tn.o 510. Code generators are then called on each of the optimizer intermediate files t1.opt 540, t2.opt 545, up to including tn.opt 550. Code generator options specific to each intermediate file is extracted from the Pre-IPO object files t1.o 500, t2.o 505, up to and including, tn.o 510.

Interprocedural Optimizer

IPO 515 is invoked twice during the compilation process. IPO 515 can be invoked by -xipo option. IPO augments in the first phase of the compilation process additional sections to object files to pass information to the second phase that the object files go through in the IPO process. Information that is passed includes intermediate representation (ir) information that is generated as an input to IPO 515; options provided to the optimizer 535; options passed to code generators such as code generators 555, 560, and 565; and information required for consistency checks. In a second phase, IPO 515 is used to extract “ir” information from object files when the object files are ready for linking. In addition to the “ir” information the options to the optimizer 535 are also extracted. Optimizer 535 is then invoked with all the “ir” information allowing cross compilation of files. Additionally options passed to code generators such as code generators 555, 560, and 565 are extracted by IPO 515 to invoke code generators for each of the optimized “ir” files and produce Post-IPO object files. IPO 515 also serves the function of adding back all sections to the Post-IPO object files that were added in the first phase of Pre-IPO object files. IPO 515 also provides for the elimination of redundant re-optimizations by using dependency checks.

Two Phases of IPO Framework

In the first phase the compilation process compiles source files with the “.c” extension to object files with the “.o” extension. Extra sections are added to the object files to hold original intermediate representation (ir) information generated by the compiler front end. These are Pre-IPO object files.

In the second phase, the IPO extracts the “ir” information as a file from each of the object files and passes “ir” information to the optimizer 535 in a single invocation step whereupon interprocedural optimization is performed. Optimized “ir” files are passed to a code generator to generate code. Optimized object files are processed by the IPO to generate Post-IPO object files.

The following is an example of the commands a user may invoke in the first and second phases of the IPO framework process. If three source files, t1.c, t2.c, and t3.c are to be compiled by a C language driver with IPO, typical compilation of these files will explicitly generate object files and then link the object files. In this particular editor screen, “cc” invokes the C language driver, and -xipo invokes the IPO framework.

cc -xipo -xO4 t1.c -c

cc -xipo -xO4 t2.c -c

cc -xipo -xO4 t.3.c -c

When the command is complete, t1.o, t2.o, and t3.o are created with additional sections containing “ir” information.

In the second phase the following command can be invoked.

cc -xipo -xO4 t1.o t2.o t3.o

Before the linker is invoked, the driver invokes IPO. IPO extracts “ir” information for each object file (t1.o, t2.o, and t3.o) and invokes the IPO optimizer. IPO passes the resulting optimized “ir” files to code generator(s) to generate optimized object files.

Dependency Information

File dependency information is maintained to avoid reoptimizing source files while performing the interprocedural optimizations after changes to one or more source files. The module dependency information is generated by the optimizer and added to the PostIPO object files by adding extra information to the machine object file. IPO later uses this information to decide which files to reoptimize after any source modification. A dependency is said to be created when a function is optimized based on the content of another function. For example, a dependency, “func1” depends on “func2,” is created when the function “func1” is optimized with an assumption of some of the characteristics of function “func2.” Some examples of characteristics of a function are, modification of a global variable, absence of any modification of a global variable, or simply the content of the whole function.

If the function “func2” is modified by the user, there is a possibility that an assumption made earlier in optimizing the function “func1” is violated by the modification. The function “func1” then needs to be reoptimized to reflect the change. IPO carries the function dependency information to file level, so it can decipher that, for example, t1.c needs to be reoptimized if there exists a function in a source file which is dependent on a function in another source file and the second source file has been modified.

The following to decide which files must be reoptimized during the second pass on optimizer. An object file will be reoptimized by using the “ir” information in the object file if one of the following conditions holds:

1. It is a PreIPO object file.

2. The link line is changed from the previous compilation.

3. It was dependent on another file which has been recompiled without passing through a second optimization (i.e. a file it was dependent on has since become a classic object file).

4. It is dependent on other file which is being reoptimized during the current compilation.

Therefore all PreIPO object files must be optimized because the PreIPO object files do not include any crossfile optimizations.

To make sure that a PostIPO object file generated for one executable (i.e., with one set of object files) does not get used for another executable (i.e., with another set of object files), the current link line is compared with the saved link line in the PostIPO object file, and the PostIPO object file is reoptimized if the link lines are not identical.

All files that are dependent on the files being modified must be reoptimized to take advantage of new optimization opportunities and correct any assumptions that are no longer valid.

PostIPO object files, due to cross module optimizations (i.e., cross target file optimization), have assumptions about other files. For example, if a PostIPO object file inlines a function “foo” from a first file, a second file assumes a certain definition of “foo.” A user can modify “foo” in the second file and the second file can inadvertently link with the first file without activating the PreIPO, IPO option. Since the first file had already inlined the previous version of the function “foo,” in a naive implementation of this feature the resulting executable file will be incorrect. Such errors are caught by generating an unresolved external error at link time. Whenever a file is made dependent on another, by way of cross module optimizations. An internal global variable is created is created which is an undefined external in the module making the assumption and defined in the module about which the assumption was made.

An Example Computing and Network Environment

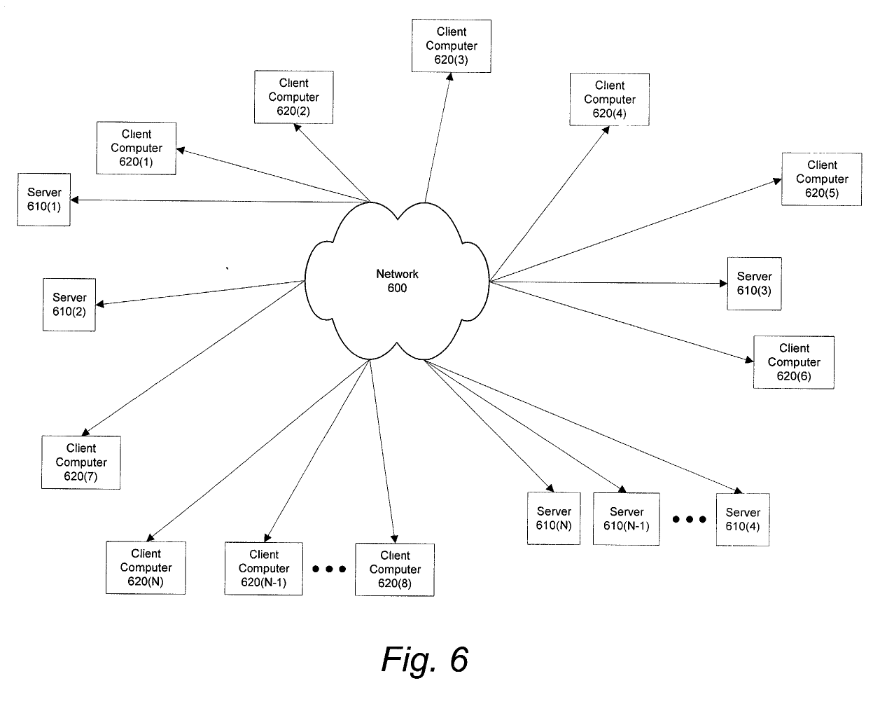

FIG. 6 is a block diagram illustrating a network environment in which a system according to the present invention may be practiced. As is illustrated in FIG. 6, network 600, such as a private wide area network (WAN) or the Internet, includes a number of networked servers 610(1)-(N) that are accessible by client computers 620(1)-(N). Communication between client computers 620(1)-(N) and servers 610(1)-(N) typically occurs over a publicly accessible network, such as a public switched telephone network (PSTN), a DSL connection, a cable modem connection or large bandwidth trunks (e.g., communications channels providing T1 or OC3 service). Client computers 620(1)-(N) access servers 610(1)(N) through, for example, a service provider. This might be, for example, an Internet Service Provider (ISP) such as America On-Line™, Prodigy™, CompuServe™ or the like. Access is typically had by executing application specific software (e.g., network connection software and a browser) on the given one of client computers 620(1)-(N).

One or more of client computers 620(1)-(N) and/or one or more of servers 610(1)-(N) may be, for example, a computer system of any appropriate design, in general, including a mainframe, a mini-computer or a personal computer system. Such a computer system typically includes a system unit having a system processor and associated volatile and non-volatile memory, one or more display monitors and keyboards, one or more diskette drives, one or more fixed disk storage devices and one or more printers. These computer systems are typically information handling systems which are designed to provide computing power to one or more users, either locally or remotely. Such a computer system may also include one or a plurality of I/O devices (i.e., peripheral devices) which are coupled to the system processor and which perform specialized functions. Examples of I/O devices include modems, sound and video devices and specialized communication devices. Mass storage devices such as hard disks, CD-ROM drives and magneto-optical drives may also be provided, either as an integrated or peripheral device. One such example computer system, discussed in terms of client computers 620(1)-(N) is shown in detail in FIG. 6.

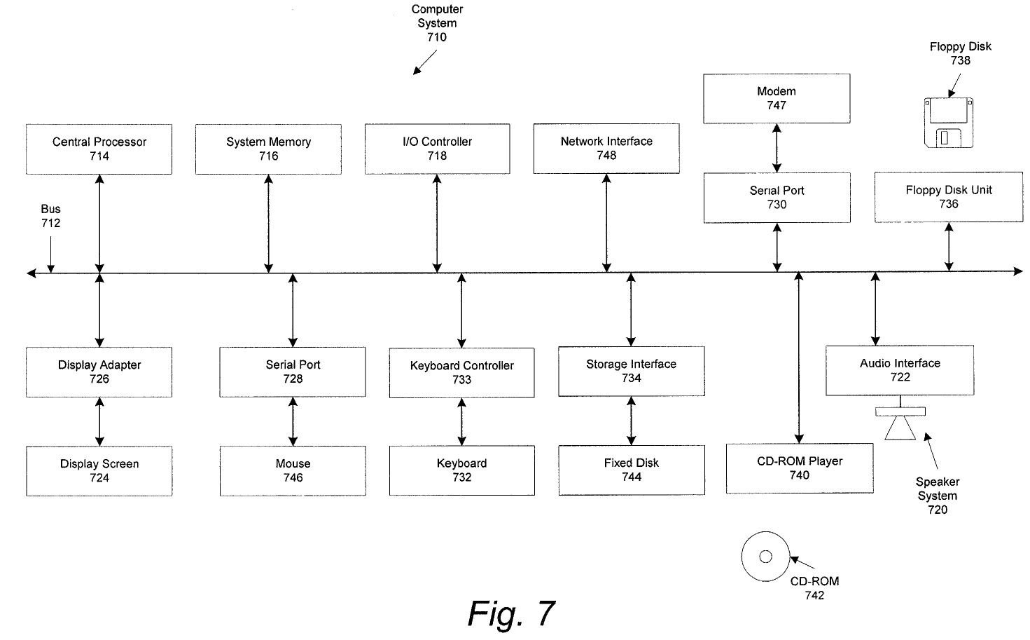

FIG. 7 depicts a block diagram of a computer system 710 suitable for implementing the present invention, and example of one or more of client computers 620(1)-(N). Computer system 710 includes a bus 712 which interconnects major subsystems of computer system 710 such as a central processor 714, a system memory 716 (typically RAM, but which may also include ROM, flash RAM, or the like), an input/output controller 718, an external audio device such as a speaker system 720 via an audio output interface 722, an external device such as a display screen 724 via display adapter 726, serial ports 728 and 730, a keyboard 732 (interfaced with a keyboard controller 733), a storage interface 734, a floppy disk drive 736 operative to receive a floppy disk 738, and a CD-ROM drive 740 operative to receive a CD-ROM 742. Also included are a mouse 746 (or other point-and-click device, coupled to bus 712 via serial port 728), a modem 747 (coupled to bus 712 via serial port 730) and a network interface 748 (coupled directly to bus 712).

Bus 712 allows data communication between central processor 714 and system memory 716, which may include both read only memory (ROM) or flash memory (neither shown), and random access memory (RAM) (not shown), as previously noted. The RAM is generally the main memory into which the operating system and application programs are loaded and typically affords at least 66 megabytes of memory space. The ROM or flash memory may contain, among other code, the Basic Input-Output system (BIOS) which controls basic hardware operation such as the interaction with peripheral components. Applications resident with computer system 710 are generally stored on and accessed via a computer readable medium, such as a hard disk drive (e.g., fixed disk 744), an optical drive (e.g., CD-ROM drive 740), floppy disk unit 736 or other storage medium. Additionally, applications may be in the form of electronic signals modulated in accordance with the application and data communication technology when accessed via network modem 747 or interface 748.

Storage interface 734, as with the other storage interfaces of computer system 710, may connect to a standard computer readable medium for storage and/or retrieval of information, such as a fixed disk drive 744. Fixed disk drive 744 may be a part of computer system 710 or may be separate and accessed through other interface systems. Many other devices can be connected such as a mouse 746 connected to bus 712 via serial port 728, a modem 747 connected to bus 712 via serial port 730 and a network interface 748 connected directly to bus 712. Modem 747 may provide a direct connection to a remote server via a telephone link or to the Internet via an internet service provider (ISP). Network interface 748 may provide a direct connection to a remote server via a direct network link to the Internet via a POP (point of presence). Network interface 748 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., bar code readers, document scanners, digital cameras and so on). Conversely, it is not necessary for all of the devices shown in FIG. 7 to be present to practice the present invention. The devices and subsystems may be interconnected in different ways from that shown in FIG. 7. The operation of a computer system such as that shown in FIG. 7 is readily known in the art and is not discussed in detail in this application. Code to implement the present invention may be stored in computer-readable storage media such as one or more of system memory 716, fixed disk 744, CD-ROM 742, or floppy disk 738. Additionally, computer system 710 may be any kind of computing device, and so includes personal data assistants (PDAs), network appliance, X-window terminal or other such computing device. The operating system provided on computer system 710 may be MS-DOS®, MS-WINDOWS®, OS/2®, UNIX®, Linux® or other known operating system. Computer system 710 also supports a number of Internet access tools, including, for example, an HTTP-compliant web browser having a JavaScript interpreter, such as Netscape Navigator® 8.0, Microsoft Explorer® 8.0 and the like.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing described embodiment wherein the different components are contained within different other components (e.g., the various elements shown as components of computer system 710). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

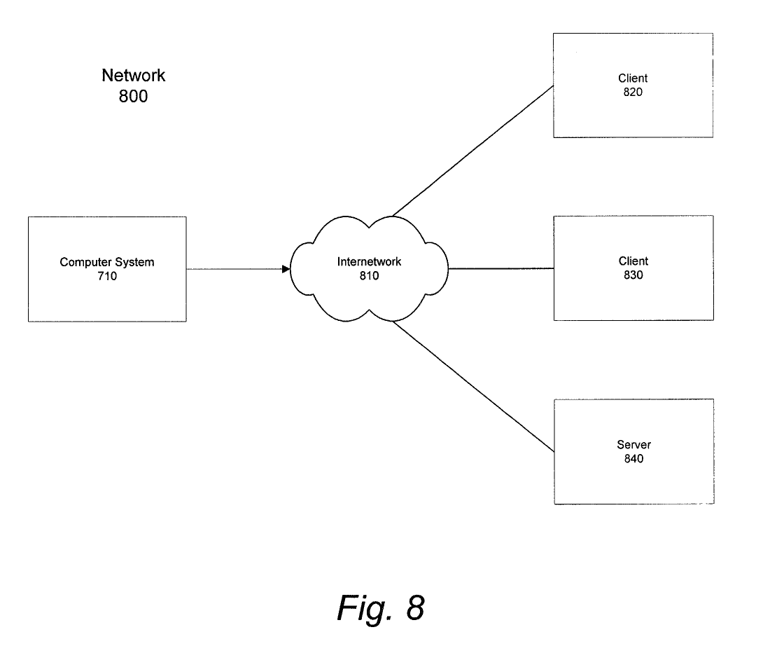

FIG. 8 is a block diagram depicting a network 800 in which computer system 810 is coupled to an internetwork 810, which is coupled, in turn, to client systems 820 and 830, as well as a server 840. Internetwork 810 (e.g., the Internet) is also capable of coupling client systems 820 and 830, and server 840 to one another. With reference to computer system 810, modem 847, network interface 848 or some other method can be used to provide connectivity from computer system 810 to internetwork 810. Computer system 810, client system 820 and client system 830 are able to access information on server 840 using, for example, a web browser (not shown). Such a web browser allows computer system 810, as well as client systems 820 and 830, to access data on server 840 representing the pages of a website hosted on server 840. Protocols for exchanging data via the Internet are well known to those skilled in the art. Although FIG. 8 depicts the use of the Internet for exchanging data, the present invention is not limited to the Internet or any particular network-based environment.

Referring to FIGS. 6, 7 and 8, a browser running on computer system 810 employs a TCP/IP connection to pass a request to server 840, which can run an HTTP “service” (e.g., under the WINDOWS® operating system) or a “daemon” (e.g., under the UNIX® operating system), for example. Such a request can be processed, for example, by contacting an HTTP server employing a protocol that can be used to communicate between the HTTP server and the client computer. The HTTP server then responds to the protocol, typically by sending a “web page” formatted as an HTML file. The browser interprets the HTML file and may form a visual representation of the same using local resources (e.g., fonts and colors).

Although the present invention has been described in connection with several embodiments, the invention is not intended to be limited to the specific forms set forth herein, but on the contrary, it is intended to cover such alternatives, modifications, and equivalents as can be reasonably included within the scope of the invention as defined by the appended claims.

What is claimed is:

1. A method for compiling program files comprising:
optimizing the program files into object files, wherein the object files are comprised of information indicating optimization;
maintaining cross modular functional relationship between object files;
extracting the information indicating optimization; and
linking the object files to create an executable output file.

2. The method for compiling program files of claim 1 further comprising:
creating intermediate representation files prior to optimizing the program files.

3. The method for compiling program files of claim 2 wherein information is extracted regarding the intermediate representation files.

4. The method for compiling program files of claim 1 wherein the object files are further comprised of:
information related to code generators.

5. The method of claim 4 of compiling program files further comprising:
extracting the information related to code generators.

6. A framework for compiling program files comprising:
an optimizer for optimizing program files into object files, wherein the object files are comprised of information indicating optimization; wherein the optimizer further extracts the information indicating optimization; and
a linker linking the object files to create an executable output file.

7. The framework for compiling program files of claim 6 wherein:
the optimizer creates intermediate representation files.

8. The framework for compiling program files of claim 7 wherein the optimizer extracts information regarding the intermediate representation files.

9. The framework for compiling program files of claim 6 wherein:
the object files are further comprised of:
information related to code generators.

10. The framework for compiling program files of claim 9 wherein:
the optimizer extracts the information related to code generators.

11. A computer system comprising:
a processor;
a computer readable medium coupled to the processor; and
computer code, encoded in the computer readable medium, configured to cause the processor to compile program files comprising of:
optimizing the program files into object files, wherein the object files are comprised of information indicating optimization;
maintaining cross modular functional relationship between object files;
extracting the information indicating optimization; and
linking the object files to create an executable output file.

12. The computer system of claim 11 wherein the processor is further configured to comprise of:
creating intermediate representation files prior to optimizing the program files.

13. The computer system of claim 12 wherein information is extracted regarding the intermediate representation files.

14. The computer system of claim 11 wherein the object files are further comprised of:
information related to code generators.

15. The computer system of claim 14 wherein the processor is further configured to comprise of:
extracting the information related to code generators.

16. An apparatus for compiling program files comprising:
means for optimizing the program files into object files, wherein the object files are comprised of information indicating optimization;
means for maintaining cross modular functional relationship between object files;
means for extracting the information indicating optimization; and
means for linking the object files to create an executable output file.

17. The apparatus for compiling program files of claim 16 further comprising:
means for creating intermediate representation files prior to optimizing the program files.

18. The apparatus for compiling program files of claim 17 wherein information is extracted regarding the intermediate representation files.

19. The apparatus for compiling program files of claim 16 wherein the object files are further comprised of:
information related to code generators.

20. The method of claim 19 of compiling program files further comprising:
extracting the information related to code generators.

21. A computer program product, encoded in computer readable media, comprising:
a first set of instructions, executable on a computer system, configured to optimize program files into object files, wherein the object files are comprised of information indicating optimization;
a second set of instructions, executable on the computer system, configured to maintaining cross modular functional relationship between object files;
a third set of instructions, executable on the computer system, configured to extract the information indicating optimization; and
a fourth set of instructions, executable on the computer system, configured to link the object files to create an executable output file.

22. The computer program product of claim 21 further comprising:
a sixth set of instructions, executable on a computer system, configured to create intermediate representation files prior to optimizing the program files.

23. The computer program product of claim 2 wherein information is extracted regarding the intermediate representation files.

24. The computer program product of claim 21 wherein the object files are further comprised of:
information related to code generators.

25. The computer program product of claim 24 further comprising
a sixth set of instructions, executable on a computer system, configured to extract the information related to code generators.
